(19) United States
(12) Patent Application Publication
(10) Pub. No.: US 2012/0198837 A1
(43) Pub. Date: Aug. 9, 2012

(54) TURBOCHARGER CONTROL STRATEGY TO INCREASE EXHAUST MANIFOLD PRESSURE

(76) Inventor: Peter Johann Medina, San Diego, CA (US)

(21) Appl. No.: 13/369,971

(22) Filed: Feb. 9, 2012

Related U.S. Application Data
(60) Provisional application No. 61/441,225, filed on Feb. 9, 2011.

(51) Int. Cl. F02B 37/18

(52) U.S. Cl. 60/602

(57) ABSTRACT

A system for controlling an exhaust driven turbocharging system includes a turbocharger having an exhaust inlet, a discharge outlet, a compressor air inlet, and a compressor outlet, a compressor bypass valve having a control port, an inlet port, a discharge port, and a valve for opening and closing the discharge port, and an engine having an air inlet and an exhaust outlet, and may include a wastegate. In the system the compressor outlet of the turbocharger is connected to the air inlet of the engine and is connected to the inlet port of the compressor bypass valve. By controlling the compressor bypass valve and the wastegate higher turbine inlet pressures can be generated for use in other areas of the system. This is achieved by opening the compressor bypass valve in an unconventional area of the internal combustion engine's range where it would normally remain closed.

### RELATED APPLICATIONS

This application claims the benefit of U.S. Provisional Application No. 61/441,225 filed Feb. 9, 2011.

### TECHNICAL FIELD

This application relates to turbocharger systems within internal combustion engines, more particularly, to exhaust-driven turbochargers and the improvement of the power output and overall efficiency of the internal combustion engine.

### BACKGROUND

Internal combustion engines, its mechanisms, refinements and iterations are used in a variety of moving and non-moving vehicles or housings. Today, for examples, internal combustion engines are found in terrestrial passenger and industrial vehicles, marine, stationary and aerospace applications. There are generally two dominant ignition cycles commonly referred to as gas and diesel, or more formally as spark ignited (SI) and compression ignition (CI), respectively. More recently, exhaust-driven turbochargers have been incorporated into the system connected to the internal combustion engine to improve the power output and overall efficiency of engine.

Since diesel engines typically do not employ the use of throttle plates, there has not been a need for CBV in their application. Historically, there has not been any forethought or requirement for the CBV to operate in any manner aside from that of a binary device that directly follows the activity of the throttle plate. There have been devices, similar to CBV known in the art as pop-off valves (POV). These pop-off valves act as common pressure relief valves that open against the preload of a spring, or perhaps the programmed limits of an electronic circuit, to limit the operating pressure of the EDT in an ICE. These devices were meant to be used as fail-safe devices. We strongly believe that the present invention brings forward a need to employ the CBV in any EDT enabled ICE, including diesels.

There is a need to continue to improve the internal combustion engine, including its efficiency and power. Herein, we present a system that is effective for both SI and CI systems.

### SUMMARY

In one aspect, internal combustion engines having an exhaust driven turbocharger system are disclosed that include a compressor bypass valve and a wastegate valve that are operable synergistically to increase the turbine inlet pressure of the exhaust driven turbocharger while maintaining the pressure in the intake manifold of the engine.

In one embodiment, this type of system may include a turbocharger having an exhaust inlet, a discharge outlet, a compressor air inlet, and a compressor outlet, a compressor bypass valve comprising a control port, an inlet port, a discharge port, and a valve for opening and closing the discharge port, an engine having an air inlet and an exhaust outlet, and a means for controlling the opening and closing of the valve. The exhaust outlet of the engine is connected to the exhaust inlet of the turbocharger, and the compressor outlet of the turbocharger is connected to both the air inlet of the engine and the inlet port of the compressor bypass valve. The system may also include a wastegate valve connected to the exhaust outlet of the engine that is operable to be maintained in a closed position while the valve in the compressor bypass valve is maintained in an open position. These two valve may be synergistically open and closable, and even partially openable, to maintain a predetermined or desired intake manifold pressure while desirably increasing the exhaust manifold pressure.

In another aspect, processes for increasing the turbine inlet pressure of exhaust driven turbochargers are disclosed that utilize a compressor bypass valve disposed at the compressor discharge of the turbocharger. Using a system such as the one describe above, and herein in more detail, the process may include the step of increasing the exhaust manifold pressure feeding into an exhaust driven turbocharger by opening the compressor bypass valve during positive intake manifold pressure conditions.

In another embodiment, the processes may include the step of increasing the pressure in the exhaust manifold by referencing a pressure in the intake manifold against the mechanical operating conditions of a control valve in the compressor bypass valve, and maintaining a predetermined boost pressure in the intake manifold by operating the control valve to control the exhaust manifold pressure.

### BRIEF DESCRIPTION OF THE DRAWINGS

FIG. 1 is a diagram including flow paths and flow direction of one embodiment of an internal combustion engine turbo system.

FIG. 2 is a flow chart indicating a sequence of controls for controlling a turbo system such as the one in FIG. 1, in particular for increasing the exhaust manifold pressure.

FIG. 3 is graph showing the relationship of control components in the system and their produced effects.

FIG. 4 is an enlarged cross-sectional view of the compressor bypass valve included in FIG. 1 in an open position.

FIG. 5 is an enlarged cross-sectional view of the compressor bypass valve included in FIG. 1 in a closed position.

### DETAILED DESCRIPTION

The following detailed description will illustrate the general principles of the invention, examples of which are additionally illustrated in the accompanying drawings. In the drawings, like reference numbers indicate identical or functionally similar elements.

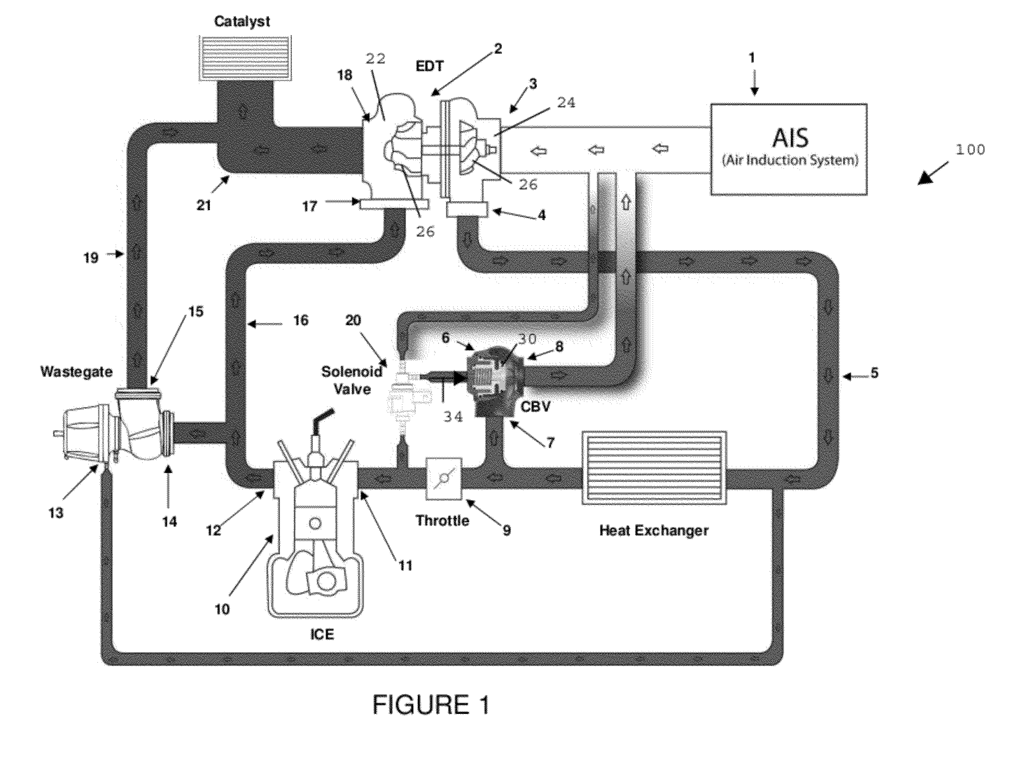

FIG. 1 illustrates one embodiment of an internal combustion engine turbo system, generally designated 100. The turbo system 100 includes the following components in controlling the operating parameters of a turbocharger: an exhaust-driven turbo charger (“EDT”) 2 with a turbine section 22 and compressor section 24, a turbine bypass valve commonly referred to as a wastegate 13 and a compressor bypass valve 6 (“CBV”). The EDT includes an exhaust housing 17, 18 containing a turbine wheel 26 that harnesses and converts exhaust energy into mechanical work through a common shaft to turn a compressor wheel 28 that ingests air, compresses it and feeds it at higher operating pressures into the inlet 11 of the internal combustion engine 10.

Still referring to FIG. 1, the wastegate 13 is a control valve used to meter the exhaust volume 16 coming from the exhaust manifold 12 of the internal combustion engine 10 and the energy available to power the EDT turbine wheel 26. The wastegate 13 works by opening a valve (not shown) to bypass 19 so that exhaust flows away from the turbine wheel 26, thereby having direct control over the speed of the EDT 2 and the resultant operating pressure of the ICE intake manifold. The wastegate 13 may have any number of embodiments, including the embodiments disclosed in applicant's U.S. patent application Ser. No. 12/717,130, which is incorporated by reference herein in its entirety.

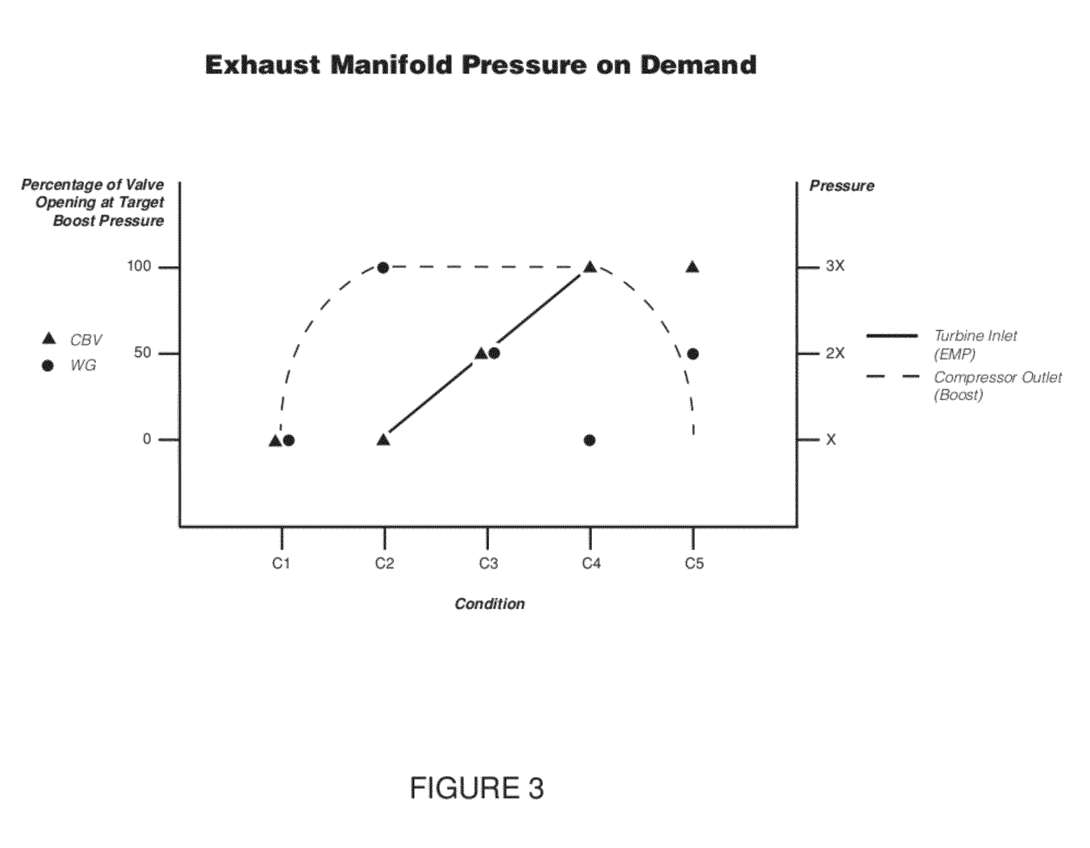

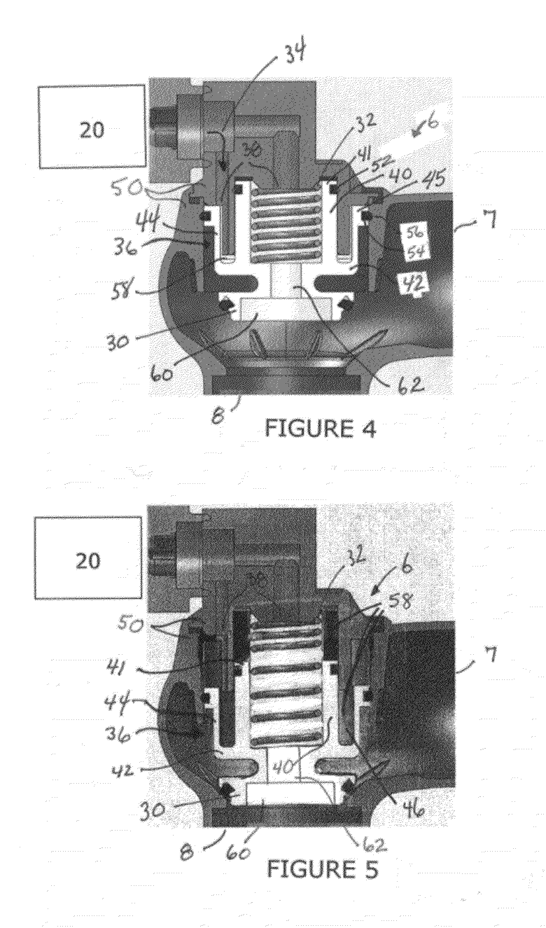

By definition, the compressor bypass valve 6 is a regulating valve located in the passageway 5 between the discharge port 4 (also called an exhaust outlet) of a compressor section 24 of the EDT 2, be it exhaust or mechanically driven, and the ICE inlet 11. As illustrated in FIG. 1 and the enlarged views in FIGS. 3-4, one embodiment of the CBV 6 includes a discharge port 8. The discharge port 8 may be, but is not limited to, one that is vented to atmosphere or re-circulated back into the compressor's ambient inlet 3 (as shown in FIG. 1).

A CBV is typically used exclusively on an SI ICE with a throttle plate 9. At any given ICE operating range, the EDT can be spinning up to 200,000 revolutions per minute (RPM). The sudden closing of the throttle 9 does not immediately decelerate the RPM of the EDT 2. Therefore, this creates a sudden increase in pressure in the passages between the closed throttle and EDT compressor section 24 such as passage 5. The CBV 6 functions by relieving, or bypassing this pressure away from the compressor section 24 of the EDT 2. The CBV 6 in FIGS. 1 and 3-4, however, is a multi-chambered valve that is capable of employment in any EDT enabled ICE, including diesels.

The CBV 6, FIGS. 1 and 4-5, includes an inlet port 7, the discharge port 8 (mentioned above), a valve 30, a piston 36 connected to the valve 30, and one or more control ports 38. The piston 36 includes a central shaft 40 having a first end 41 and a second end 42. The first end includes a sealing member 52 such as an O-ring for sealing engagement with the housing 50. Extending from the second end 42 is a flange 44 extending toward the first end 41, but spaced a distance away from the central shaft 40 of the piston 36. The flange 44 terminates in a thickened rim 45 having a seat 54 for a second sealing member 56 such as an O-ring. The flange 44 defines a general cup-shaped chamber 46 (best seen in FIG. 5) between the central shaft and itself, and when housed inside housing 50 define a plurality of chambers 58. The piston 36 is movable between an open position (shown in FIGS. 1 and 4) and a closed position (shown in FIG. 5) by the biasing spring 32, by actuating pressure 34, or a combination thereof.

The compressor bypass valve 6 may also include a first through port 60 formed axially through the valve 30 and a second through port 62 formed axially through the piston 26. The second through port 62 is at least partially aligned with the first through port 60. The first and second through ports 60, 62 provide fluid communication between the inlet port 7 and at least one of the control ports 38.

The modern ICE has very stringent emissions regulations that it has to meet in order to be approved by government agencies worldwide prior to commercial offering. The marketplace has also put demands on vehicle and industrial manufacturers to significantly improve the fuel efficiency of the ICE. These factors have led to the use of a strategy known as exhaust gas recirculation (EGR). This is a process wherein spent exhaust gases from the combustion process are re-introduced into the inlet of the engine. One skilled in the art can appreciate that in order for EGR to work effectively, there should exist a pressure differential between the EGR source and the target inlet. The ICE engineer is always faced with the challenge of balancing EDT design that will have maximum efficiency, whilst meeting the requirements for effective EGR.

In any EDT system, there exists operating pressures in the compressor inlet 3, intake manifold 5, 11 (IM), exhaust manifold 12, 16 (EM) and exhaust 18, 21. With respect to FIG. 1, the EDT compressor inlet is defined as the passageway from the air intake system 1 to the inlet 3 of the EDT compressor section 26, typically operating at an ambient pressure in a single stage EDT system. The engine's inlet manifold is defined as the passages between the EDT compressor discharge 4 and the ICE intake valve(s) 11. The engine's exhaust manifold is defined as the passages between the ICE exhaust valve 12 and the EDT turbine inlet 17. The exhaust is broadly defined as any passageway after the EDT turbine discharge 18. In order to achieve effective EGR, the pressures in the exhaust manifold should be significantly higher than the pressures found in the inlet manifold in order for exhaust gas to flow in that direction. The design of EDT and the varied combinations that exist of compressor and exhaust sizes is extensive. To summarize, smaller EDT exhaust profiles produce higher desired exhaust manifold pressures at the expense of lower efficiencies. One can appreciate that engineers in the art weigh a fine balance between achieving efficiency and EGR effectiveness.

The present invention enables the ICE engineer to significantly increase the operating pressure of the exhaust manifold 12, 16 on command, herein referred to as the Effect. By opening the CBV 6, see FIG. 4, at any point when the operating pressure in the intake manifold 5, 11 is positive, or a condition commonly referred to as boost, an Effect will be produced wherein one will cause the operating pressure in the exhaust manifold 12, 16 to be higher than a comparison condition wherein the CBV 6 is held closed. In one embodiment, the operator is effectively controlling the operating pressure of the engine's intake manifold 5, 11 by utilizing the CBV 6 instead of the wastegate 13. In this condition, the pressure in the exhaust manifold 12, 16 is higher than a comparison condition where the CBV 6 is closed and the wastegate 13 is opened to achieve the same intake manifold pressure.

In yet another embodiment, one could simply produce a leak or bleed of pressure in the intake manifold 5, 11 to produce the Effect, which may be across a broad operating range. And another embodiment may be a very precise control of when the CBV 6 is actuated open in the operating range of any given ICE 10 so as to produce the Effect for a limited range. This range will be determined by the parameters that the ICE engineer seeks to achieve, which can be many factors to include, but not limited to, increased EGR flow rate, reduced power output, reduced fuel consumption or lower exhaust emissions values.

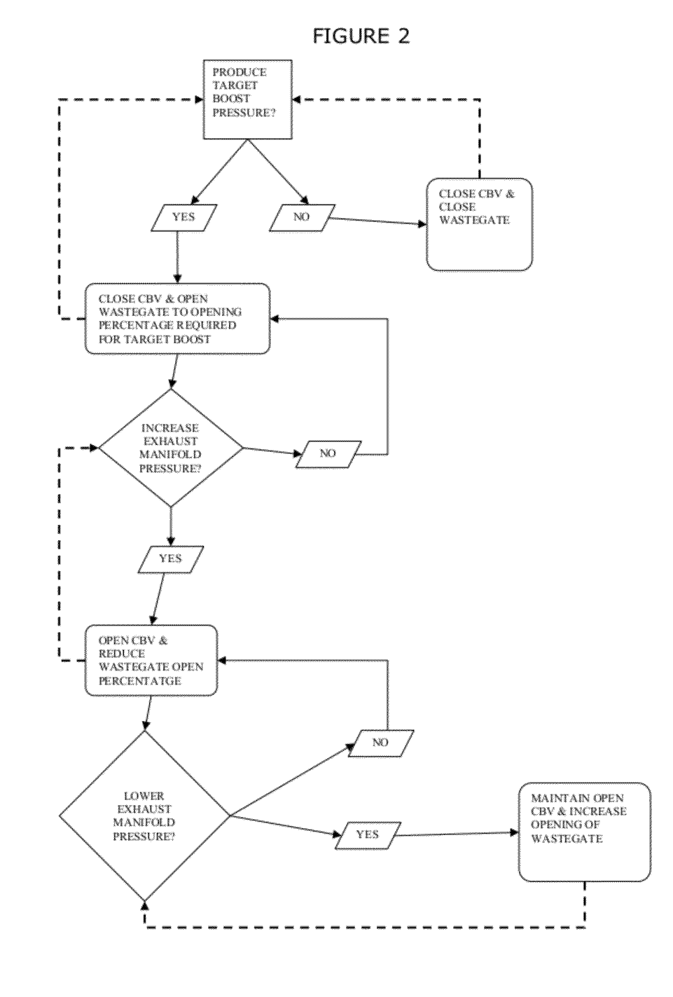

Now referring to FIG. 2, in order to maximize the Effect, one would keep the wastegate 13 closed to achieve the highest exhaust manifold 12, 16 pressure. To reduce the Effect, one would increase the opening of the wastegate 13 and relieve the pressure in the exhaust manifold 12, 16. The Effect of increasing the exhaust manifold 12, 16 pressure using only control strategy is completely dependent on the control of the CBV 6.

There exists several methodologies for controlling the opening and closing of embodiments of a CBV 6 that can produce the Effect. In one embodiment, the CBV 6 can be made to open naturally against a biasing spring 32, where when operating pressure exceeds the pre-load force of the spring, the CBV 6 opens and then regulates against the pre-load force to maintain a given operating pressure at the intake manifold 5, 11. In another iteration, the CBV 6 is signaled to open by an electronic circuit when a parameter is reached, either directly in the case of a direct acting solenoid or motor driven unit, or pneumatically via a control solenoid 20 that signals the CBV 6 to actuate by controlling the delivery of actuating pressure 34. Once signaled open, the CBV 6 operates similar to the previous example. Additionally, a CBV 6, direct-acting or pneumatic, is signaled to open by having a circuit apply a control frequency with a given duty cycle in order to produce a target operating pressure in the intake manifold 5, 11 against which to regulate, or perhaps determine the lift and position of the valve 30 in the CBV 6.

The mechanism of action that produces the Effect is quite logical. The application of EDTs today require the implementation of turbine speed control. Without this strategy the operating boost pressure at the ICE inlet valve would continue to increase to undesired levels, or the engineer would have to use an unreasonably large turbine to limit the EDT speed at the maximum engine operating speed, thereby sacrificing ICE power output response. ICE engineers have therefore, employed the use of exhaust-based strategies for turbine speed control. Forms of turbine speed control include, but are not limited to, variable geometry turbines, variable nozzle area turbines and the wastegate 13. All of these strategies serve to control the amount of energy available to the turbine wheel by regulating the availability of exhaust gas volume. As a result, EDT turbines and their particular efficiency signatures are matched to ICEs based on an assumption that there will be apportioned exhaust volumes 19 that will not be forced through that given turbine. The target control parameter that turbine speed control produces is boost or inlet valve operating pressure.

When the strategy switches from controlling the target boost pressure via the turbine to one that utilizes the CBV 6, one effectively forces the turbine to accommodate all of the exhaust flow that would be produced by the ICE 10 at the same boost pressure. Essentially, the turbine is now operating outside of its design parameters and well outside of its target efficiency, thereby producing the Effect of significantly higher exhaust manifold pressures. It is therefore logical and empirically validated, that the exhaust manifold pressures can be adjusted up or down by controlling the closing and opening of the wastegate 13, for example, when the CBV 6 is used as the boost control strategy.

A variety of control methodologies are known, or may be developed hereafter, that enable the sensing of system operating pressures or referencing the system operating pressure against the mechanical operation of a valve therein and thereafter produce an output to achieve an Effect. The system arrangements can be as fundamental as pneumatically communicating pressure signals that are produced in the system are to a mechanical actuators surface area acting against a spring bias. As system conditions change, then the performance of the actuator will change accordingly in a simple closed-loop logic. The control system can also increase in complexity to include pressure sensors that communicate signals to an electronic processing unit that integrates those signals electronically, or against a table of comparative values, and then output a control signal to a solenoid that will pneumatically control the actions of the actuator.

The relationship between the control variables of an ICE EDT are best characterized by the conditions in FIG. 3. In Condition 1 the turbo system 100 is not producing any boost pressure or exhaust manifold pressure, therefore the CBV 6 and wastegate 13 are kept closed in a 0% open state which will enable the system to produce boost pressure at the intake manifold 5, 11, at a given ICE operating speed. In Condition 2, the system has already achieved its target boost pressure at the intake manifold 5, 11 and needs to maintain this target value. Therefore, the wastegate 13 valve is opened to 100% of the value required to sustain the target boost at the intake manifold 5, 11, and the CBV 6 is kept closed. Condition 2 is what would be considered the normal condition heretofore. The exhaust manifold pressure at the turbine inlet 17 of the EDT 2, achieves the baseline value that is commonly seen in systems that are not employing the present invention. In Condition 3, you will notice that the system continues to maintain the same boost pressure as Condition 2. However, the opening of the wastegate 13 has been reduced to 50% of what is required to maintain the same boost pressure, so the CBV 6 must be opened to relieve excess boost pressure and maintain the target value for the intake manifold 5, 11. In Condition 4, FIG. 3 illustrates that the system is still maintaining the same boost pressure value at the intake manifold 5, 11, but that the wastegate 13 is now closed and the CBV 6 is being utilized to achieve and maintain the target boost pressure for the intake manifold 5, 11. As a result, the exhaust manifold pressure value increases. FIG. 3 illustrates that control of the CBV 6 and wastegate 13, as set forth in the flow chart in FIG. 2, are directly related to maintaining a given boost pressure value for the intake manifold 5, 11. If the CBV 6 is closed and the wastegate 13 opening is reduced, then the boost pressure will rise and exceed the target. Conversely, if the wastegate 13 opening is increased, then the boost pressure will decrease and not reach the target value. If the wastegate 13 is at 100% and the CBV 6 is at 50%, as shown in Condition 5, the boost pressure will also decrease. In order to maintain a given boost pressure value while opening the CBV 6, the wastegate 13 must also be adjusted accordingly. What one can appreciate is that the present invention allows the system to maintain the target pressure at the intake manifold 5, 11 and increase the exhaust manifold pressure.

The production of the Effect has been validated across different ICE ignition strategies (both SI and CI) and EDT variations. The present invention solves many problems that face the ICE engineer today as it relates to controlling engine exhaust manifold pressures. Additionally, with the increasing costs associated with diesel ICEs, the Effect may provide a strategy that will aid in controlling oxygen levels in catalysts, particulate after-treatment systems and may aid in temperature control for future technologies such as lean NOX catalysts. Overall, the Effect may enable the reduction of turbocharged ICE architecture costs, increase operating efficiencies and give engineers an additional tool to further the art.

Having described the invention in detail and by reference to preferred embodiments thereof, it will be apparent that modifications and variations are possible without departing from the scope of the invention which is defined in the appended claims.

What is claimed is:

1. A system for controlling an exhaust driven turbocharging system, comprising:
a turbocharger having an exhaust inlet, a discharge outlet, a compressor air inlet, and a compressor outlet;
a compressor bypass valve comprising a control port, an inlet port, a discharge port, and a valve for opening and closing the discharge port;
an engine having an air inlet and an exhaust outlet, the exhaust outlet connected in fluid communication to the exhaust inlet of the turbocharger;
wherein the compressor outlet of the turbocharger is connected in fluid communication to the air inlet of the engine and is connected in fluid communication to the inlet port of the compressor bypass valve; and
a means for controlling the opening and closing of the valve.

2. The system of claim 1, further comprising a wastegate valve connected to the exhaust outlet of the engine, wherein the wastegate valve is maintainable in a closed position while the valve in the compressor bypass valve is maintainable in an open position.

3. The system of claim 1, further comprising a wastegate valve connected to the exhaust outlet of the engine, wherein the wastegate valve is maintainable in an open position while the valve in the compressor bypass valve is maintainable in a closed position.

4. The system of claim 1, wherein the means for controlling the valve maintains the compressor bypass valve in an open position during a predetermined range of operation determined by an exhaust gas recirculation flow rate.

5. The system of claim 1, wherein the means for controlling the valve maintains the compressor bypass valve in an open position during a predetermined range of operation determined by a target fuel consumption rate.

6. The system of claim 1, wherein the means for controlling the valve maintains the compressor bypass valve in an open position during a predetermined range of operation determined by exhaust emission values.

7. The system of claim 1, wherein the compressor bypass valve further comprises:
a first through port formed axially through the valve;
a piston having a second through port formed axially through the piston, the piston coupled to the valve with its second through port at least partially aligned with the first through port, wherein the piston at least partially defines two or more chambers within the compressor bypass valve.

8. The system of claim 7, wherein a first of the two or more internal chambers is connected to the control port, and a second of the two or more internal chambers is connected to the second through port such that fluid communication is provided between the inlet port of the compressor bypass valve and the second of the two or more internal chambers.

9. The system of claim 1, wherein the discharge port of the compressor bypass valve is connected in fluid communication to the compressor air inlet of the turbocharger.

10. The system of claim 1, wherein the means for controlling the valve includes a biasing member, an electronic circuit, a solenoid, a motor, a pneumatic actuator, or a combination there of connected to the control port.

11. A method of controlling a turbocharger in an internal combustion engine, the method comprising:
providing the system of claim 1;
increasing the exhaust manifold pressure feeding into an exhaust driven turbocharger by opening the compressor bypass valve during positive intake manifold pressure conditions.

12. A method for controlling an exhaust driven turbocharging system, comprising:
providing an engine having a turbocharger inlet connected to an engine exhaust port via an exhaust manifold, a turbocharger outlet connected to an inlet port of a compressor bypass valve and to an engine inlet valve using an intake manifold, a solenoid valve connected to a control port of the compressor bypass valve; and
increasing the pressure in the exhaust manifold by:
referencing a pressure in the intake manifold against the mechanical operating conditions of a control valve in the compressor bypass valve; and
maintaining a predetermined boost pressure in the intake manifold by operating the control valve to control the exhaust manifold pressure.

13. The method of claim 12, further comprising:
a wastegate valve connected to the exhaust manifold; and
maintaining the predetermined boost pressure in the intake manifold by operating both the wastegate valve and the compressor bypass valve to synergistically maintain that predetermined boost pressure in the intake manifold and the exhaust manifold pressure.

14. The method of claim 13, wherein the maintaining step includes maintaining the compressor bypass valve in a partially open position while maintaining the wastegate in a partially open position.

15. The method of claim 13, wherein the maintaining step includes maintaining the compressor bypass valve in an open position while maintaining the wastegate in a closed position.

16. The method of claim 13, wherein the maintaining step includes maintaining the compressor bypass valve in an open position while maintaining the wastegate in a partially open position.

17. The method of claim 12, wherein the referencing step includes referencing an EGR flow rate.

18. The method of claim 12, wherein the referencing step includes referencing a target fuel consumption rate.
